(19) United States
(12) Patent Application Publication
(10) Pub. No.: US 2015/0060580 A1
(43) Pub. Date: Mar. 5, 2015

(54) SOLID-STATE SPAN ALIGNMENT AND PIVOT POSITIONING

(71) Applicant: Lindsay Corporation, Omaha, NE (US)

(72) Inventor: Dick Philip Welch, Elkhorn, NE (US)

(73) Assignee: Lindsay Corporation, Omaha, NE (US)

(21) Appl. No.: 14/013,789

(22) Filed: Aug. 29, 2013

(51) Int. Cl. A01G 25/16; G05B 15/02; A01G 25/09

(52) U.S. Cl. CPC A01G 25/16; A01G 25/092; G05B 15/02
USPC 239/729; 700/284

(57) ABSTRACT

A center-pivot irrigation system having a plurality of towers interconnected by a plurality of spans actuatable about a center pivot, a plurality of solid-state sensors each mounted in fixed alignment with one of the spans or towers, and a control system communicably coupled with the solid-state sensors. The solid-state sensors may send acceleration, angular acceleration, angular rotation, heading, and/or angle measurements to the control system, which may use these measurements to calculate alignment of the spans relative to each other and/or the center pivot and to calculate locations of the spans or towers using a known location of the center pivot. The solid-state sensors may be solid-state gyroscopes, solid-state accelerometers, digital compass, and/or an inertial measurement unit (IMU).

### BACKGROUND

Embodiments of the present invention relate to a system and method for irrigating fields.

Irrigation systems are frequently used to deposit water and/or pesticides throughout a field of crops. An irrigation system may include multiple spans linked together and moved through the field on frame pieces or “towers” having wheels. A center pivot irrigation system may move in a circle or semi-circle about a center pivot while a lateral-move irrigation system may move along a generally straight line across a generally-square or rectangular-shaped field.

Some center pivot irrigation systems use potentiometers and/or encoder-based sensors connected to spans or towers through adjustable mechanical linkages to determine tilt, span alignment, and position in a field. However, these potentiometers or encoder-based sensors are mechanically linked to the spans and are therefore subject to wear over time. Furthermore, they generally require initial setup by trained personnel and may be sensitive to temperature swings or other environmental variables.

### SUMMARY

Embodiments of the present invention solve the above described problems by providing an irrigation system having an improved sensing system for determining span alignment and position in a field. An embodiment of the irrigation system has a plurality of traveling towers interconnected by a plurality of spans, a plurality of solid-state sensors each mounted in fixed alignment with one of the spans or towers, and a control system communicably coupled with the solid-state sensors. The solid-state sensors may be gyroscopes, accelerometers, digital compasses, and/or inertial measurement units (IMUs) and may send acceleration, angular acceleration, angular rotation, heading, and/or angle measurements to the control system. The angle measurements may be angles measured with respect to a reference direction, a reference location, or a geomagnetic field of Earth. The control system may use the acceleration, angular acceleration, angular rotation, heading, and/or angle measurements to calculate alignment of the spans relative to each other and/or the reference direction. In some embodiments of the invention, the irrigation system may be a center-pivot irrigation system having a fixed center pivot about which the spans and towers rotate. The control system may use a known location of the center pivot, known dimensions of the spans and other hardware of the irrigation system, and measurements received from the solid-state sensors to calculate locations of the spans and/or towers.

Embodiments of the invention may also include a method for calculating and using alignment and location of the spans and/or towers. The method may receive signals from solid-state sensors mounted in fixed alignment with spans and/or tower of an irrigation system. Next, the method may calculate relative or absolute alignment of one or more of the spans and calculate a location of one or more of the spans or towers using the signals received from the solid-state sensors. The method may then increase or decrease a travel speed of the spans and towers, including either variable speed or on-off control based on the calculated alignment and/or location of the spans.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a center-pivot irrigation system constructed in accordance with an embodiment of the invention, illustrating solid-state sensors mounted at a top of each tower;

FIG. 2 is a perspective view of the center-pivot irrigation system of FIG. 1, alternatively illustrating the solid-state sensors mounted onto each span proximate to the towers;

FIG. 3 is a perspective view of the center-pivot irrigation system of FIG. 1, alternatively illustrating the solid-state sensors mounted onto spreader bars below the spans;

FIG. 4 is a perspective view of the center-pivot irrigation system of FIG. 1, alternatively illustrating the solid-state sensors mounted onto a lower portion of the towers proximate to a wheel thereof;

FIG. 5 is a perspective view of the center-pivot irrigation system of FIG. 1, alternatively illustrating the solid-state sensors mounted onto booms extending from the towers substantially perpendicular relative to a length of the spans;

FIG. 6 is a plan view of the center-pivot irrigation system illustrating angles sensed by solid-state sensors mounted on spans thereof; and

FIG. 7 is a flow chart illustrating a method of calculating alignment and/or position of spans of an irrigation system in accordance with an embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

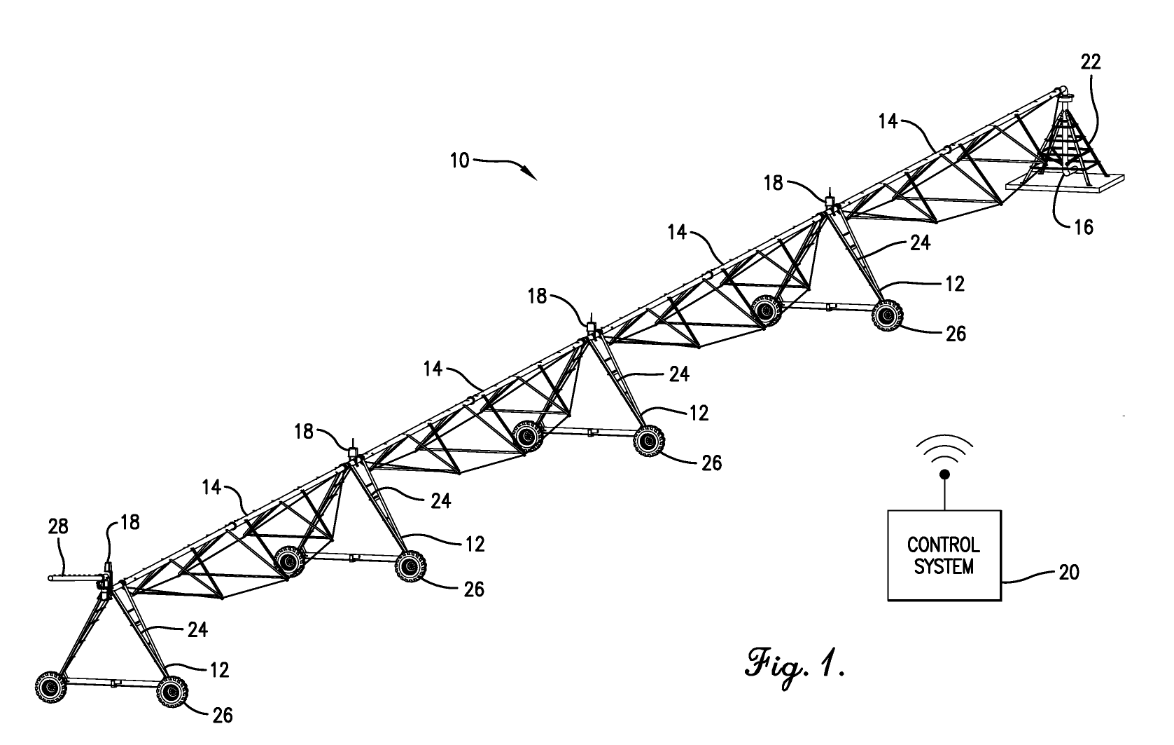

Embodiments of the present invention, as illustrated in FIGS. 1-6, include an irrigation system 10 configured for irrigating a field. The irrigation system 10 may comprise a plurality of traveling towers 12 spaced apart from each other, a plurality of spans 14 extending between and supported by the towers 12, and a fluid delivery system 16 through which water or other liquids are delivered to the field. The irrigation system may further comprise a plurality of solid-state sensors 18 each mounted in fixed alignment to one of the spans 14 and a control system 20 configured for receiving measurements from the solid-state sensors 18 and/or guiding and actuating various elements of the irrigation system 10. In some embodiments of the invention, the irrigation system 10 is a center-pivot irrigation system having a fixed center pivot 22 or fixed center tower, which serves as a center point about which the other towers 12 and spans 18 rotate or circumscribe completely or partially.

The towers 12, as illustrated in FIGS. 1-5, may each comprise a frame 24 of any shape and one or more wheels 26 rotatably attached to the frame 24. In some embodiments of the invention, the frame 24 of at least some of the towers 12 may be made of one or more rods shaped in a substantially triangular or A-frame configuration having lower leg portions configured for attaching the wheels 26 thereto. Additionally or alternatively, the frame 24 of at least some of the towers 12 may be made of one or more rods shaped in a substantially narrow rectangular shape with leg portions extending horizontally outward and then angled downward therefrom for attaching the wheels 26 thereto.

The tower wheels 26 illustrated and described herein are merely examples of mechanisms for permitting movement of the irrigation system 10. The term “wheel” or “wheels” as used herein may refer to conventional circular wheels, skis, skids, tank tracks and wheels, rollers on a track, or any mechanism on which the towers may travel relative to the ground.

The towers 12 may be independently or cooperatively actuatable to move through the field. For example, the towers 12 may have motors and/or various actuating devices attached thereto for actuating movement of the towers 12 relative to the center pivot 22. In some embodiments of the invention, the motors may actuate rotation of the wheels 26 of the towers 12. The motors may include integral or external relays so they may be turned on, off, and/reversed. The motors may also have several speeds or be equipped with variable speed drives. Furthermore, one or more of the towers 12 may also comprise a power supply, a traveling winch, and/or other various actuation components configured for actuating the towers 12 rotationally about the center pivot 22. For example, a gear motor may be coupled with a drive shaft, gears, belts, chains, sprockets, etc. to rotatably couple the gear motor with the wheels 26. In some embodiments of the invention, the wheels 26 may be rotatably attached to the towers 12 and configured to freely rotate relative to the towers 12 and/or the ground/field when the towers 12 are actuated to rotate about the center pivot 22.

The towers 12 may be spaced apart from each other, and linked together via the spans 14. For example, one of the spans 14 may laterally span a distance between a first tower and a second tower spaced apart from each other. The towers 12 may support the spans 14 a distance above the field. In some embodiments of the invention, the towers 12 may carry the spans 14 along a circular or semi-circular path about the center pivot 22. The irrigation system 10 may comprise any quantity of towers and spans required to cover a desired area of the field.

As illustrated in FIGS. 1-5, the spans 14 may each be elongated structures spanning an entire distance between adjacent ones of the towers 12. Each of the spans 14 may be fixedly or pivotally connected with at least one of the towers 12 and/or each other. In some embodiments of the invention, the spans 14 may be elongated rigid truss structures, booms, conduits pipes, bars, extension arms, or other structures of various configurations. For example, in FIGS. 1-5, the spans include elongated conduits with spreader bars mounted thereto and extending below the elongated conduits. However, the spans 14 may have any shapes and dimensions without departing from the scope of the invention. In some embodiments of the invention, one or more of the spans 14 may be an extension arm 28 or pivoting turret having a first end fixedly or pivotally joined with one of the towers 12 and a second end not joined to the towers 12 or substantially free standing.

The spans 14 may carry or otherwise support portions of the fluid delivery system 16. Specifically, portions of the fluid delivery system 16 may attach to and/or be supported by the spans 14, such that water and/or any other liquid may be dispensed at given intervals along a length of the spans 14. A plurality of sprinkler heads, spray guns, drop nozzles, or other fluid-emitting devices may be spaced along the spans 14 and/or at one or more of the towers 12 to apply water and/or other fluids to the field or land underneath the irrigation system 10.

In some embodiments of the invention, the spans 14 may be integrated with the fluid delivery system 16. For example, each of the spans 14 may comprise rigid pipes or conduits extending an entire distance between two of the towers 12 and in fluid communication with a water source, such that water may flow therethrough. In this embodiment of the invention, the spans 14 may also comprise holes formed therethrough and/or inlets and outlets for dispensing water or any other liquid desired to be applied to the field.

The fluid delivery system 16 may comprise one or more conduits and one or more fluid-emitting devices (not shown), such as sprinkler heads, drip holes formed in the conduits, spray nozzles, or other fluid emitters. Each of the fluid-emitting devices may be fixed to one of the towers 12, to the spans 14, or to any portion of the irrigation system 10. At least one of the fluid-emitting devices may comprise and/or be fluidly connected to a supply/shut-off valve for turning water on and off to the fluid-emitting devices and controlling how much water is provided to the fluid-emitting devices. The supply/shut-off valve may be actuated manually, electronically, remotely, and/or automatically by the control system 20, which may be physically and/or communicably coupled with the supply/shut-off valve. The conduits may be hoses or pipes fluidly linking the fluid-emitting devices with a fluid supply or source. A pump or any other actuation means may be used to force water or another fluid through the conduits to the fluid-emitting devices. In some embodiments of the invention, the conduits may further comprise a drop pipe fluidly connected to the conduits to allow for a drain and flushing of fluid in the conduits.

In some embodiments of the invention, a plurality of fluid supplies and/or supply hook-ups, such as hydrants, may be located at various locations relative to the field, and the conduits may be configured to attach to the nearest one of the fluid supplies. In another embodiment of the invention, the fluid supply may be a water canal or any other fluid source near the field. In this embodiment of the invention, the fluid delivery system may also comprise a pump configured to pump water from the canal through the conduits.

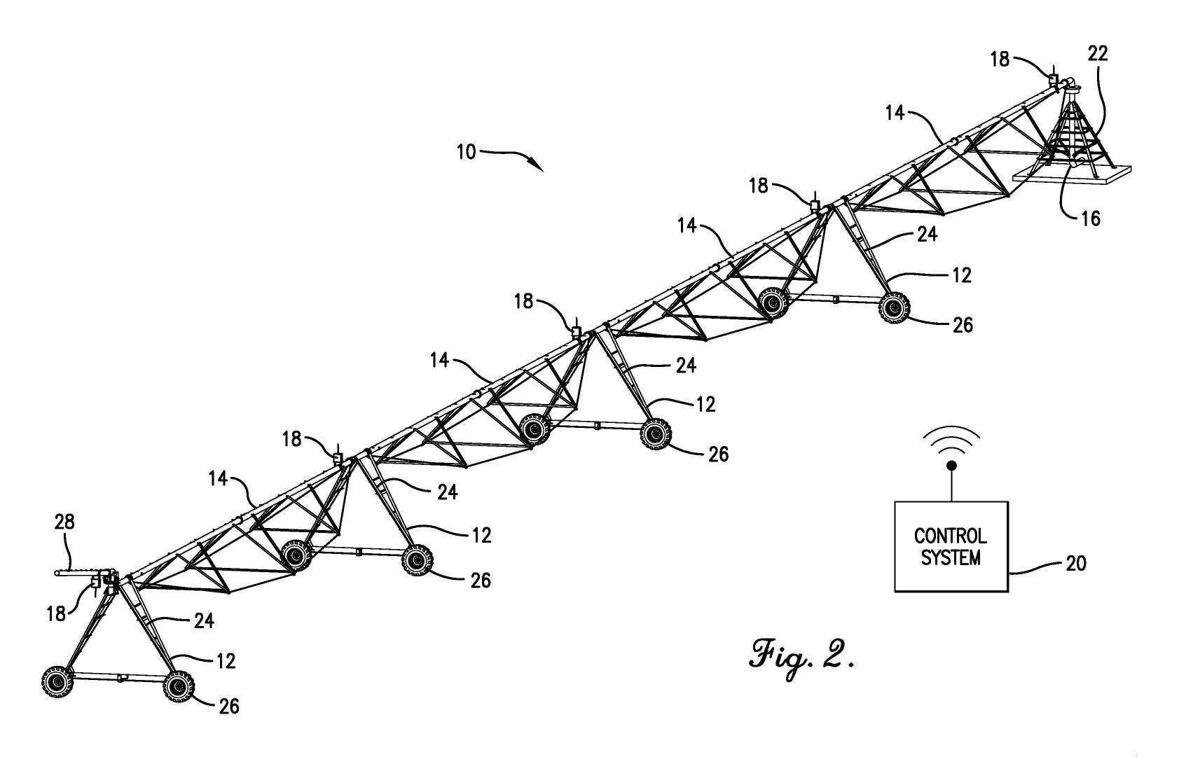

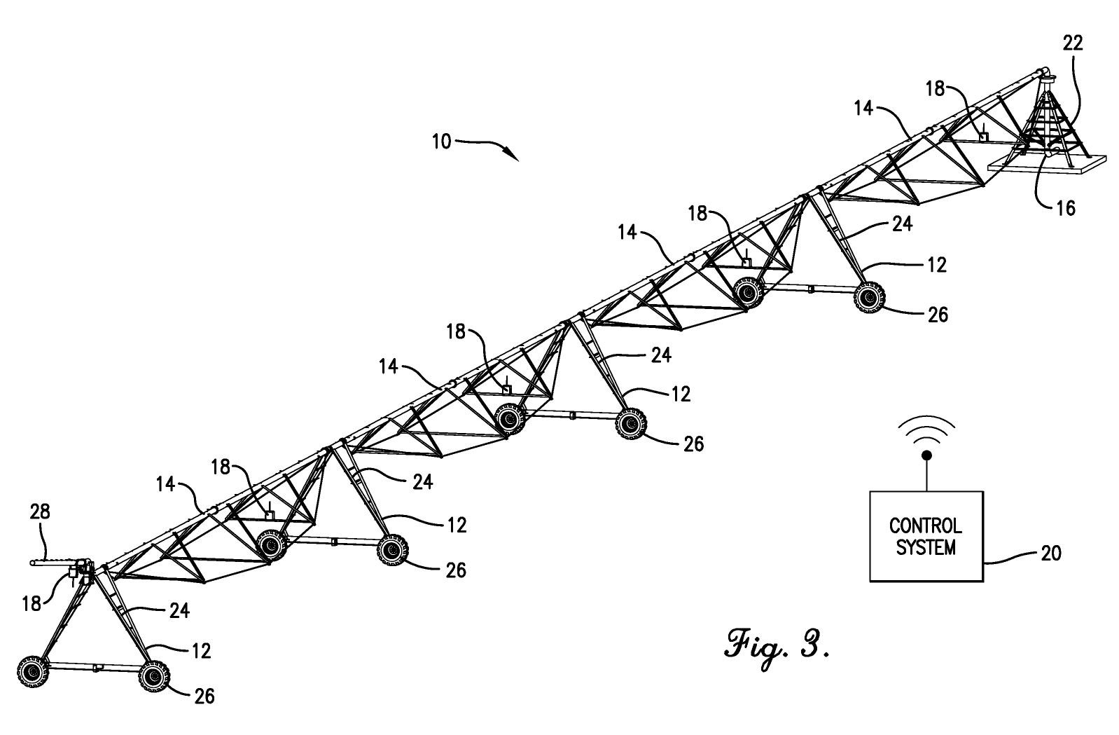

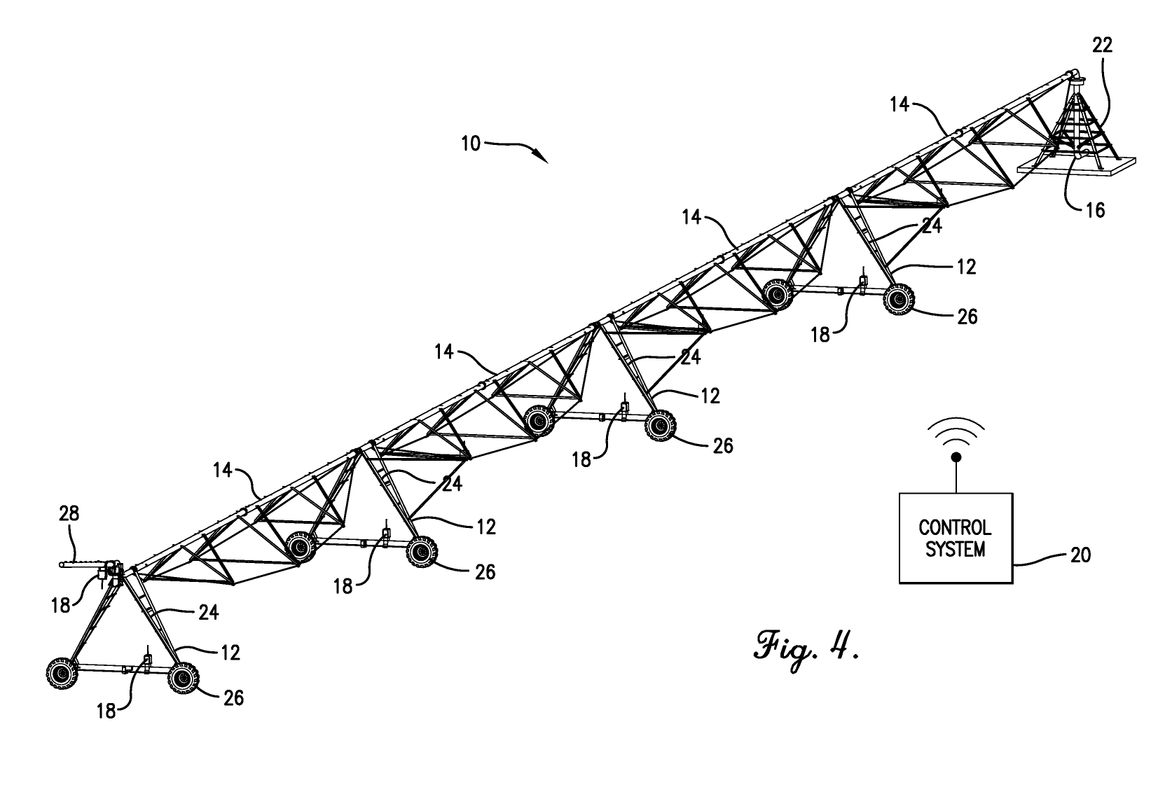

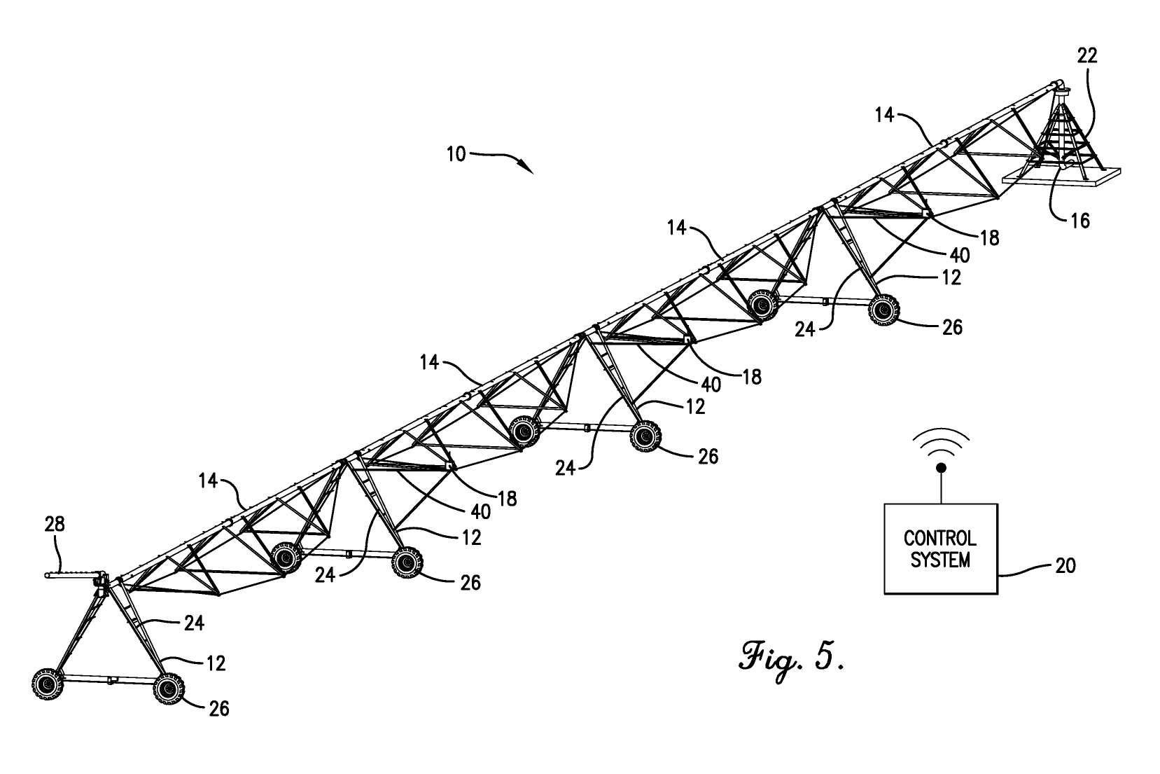

The solid-state sensors 18 may each be mounted in fixed alignment with one of the spans 14. For example, the solid-state sensors 18 may each be fixed to one of the towers 12, as in FIGS. 1 and 4, in a fixed alignment with a corresponding one of the spans 14. In FIG. 5, the solid-state sensors 18 are mounted to a boom extending from the towers 12, as later described herein. Alternatively, the solid-state sensors 18 may each be fixed directly to one of the spans 14, as illustrated in FIGS. 2-3. The solid-state sensors 18 may include microelectromechanical systems (MEMS) sensors such as digital compasses, solid-state gyroscopes, accelerometers, and/or inertial measurement units (IMUs). For example, the digital compasses may include magnetometers for measuring the strength and/or direction of magnetic fields, and the IMUs may include angular and/or linear accelerometers and/or gyroscopes. Each of the solid-state sensors 18 may be configured to measure and/or calculate rotation and/or alignment of the spans 14 to which they are fixed. Upon initial setup of the irrigation system 10, the solid-state sensors 18 may be calibrated to a reference location and/or a reference direction relative to a geomagnetic field of Earth, as later described herein. The solid-state sensors 18 may include or be communicably coupled to wired or wireless communication devices or transmitters configured for sending the measurements from the solid-state sensors 18 to the control system 20 or external computers or control system configured for calculating or inferring position and/or alignment using the transmitted measurements.

In some embodiments of the invention, as illustrated in FIG. 5, the solid-state sensors 18 may be mounted on one or more booms 40, preferably of a non-metallic composition, extending from at least one of the spans 14 and/or towers 12 in such a manner as to separate the solid-state sensors 18 from metal components of the irrigation system 10. Likewise, the booms 40 should be configured to maintain a generally fixed alignment to at least one of the spans 14 and/or towers 12, thereby minimizing any influence the metal of the irrigation system 10 and the electrical fields around the irrigation system 10 may have on measurements by the solid-state sensors 18.

The control system 20, as illustrated in FIGS. 1-5, may be communicably coupled with the solid-state sensors 18, motors or actuation devices of the wheels 26 and/or towers 12, and/or control elements of the fluid delivery system 16. Specifically, the control system 20 may be configured for calculating or inferring position and/or alignment of the spans 14 or towers 12, controlling speeds of the towers 12, pivoting of the spans 14 about the center pivot 22, turning water on or off, etc. The control system 20 may comprise any number of processors, controllers, integrated circuits, programmable logic devices, or other computing devices and resident or external memory for storing data and other information accessed and/or generated by the irrigation system 10.

The control system 20 may be physically located on one of the towers 12, on the center pivot 22, or remotely located and configured to transmit control signals to various sensors, motors, switches, and/or actuation devices of the irrigation system 10. Furthermore, in some embodiments of the invention, only portions of the control system 20 and/or memory may be remotely located from the towers 12, spans 14, and fluid delivery system 16 of the irrigation system 10. Furthermore, portions of the control system 20, memory, and/or the solid-state sensors 18 need not be physically connected to one another since wireless communication among the various depicted components is permissible and intended to fall within the scope of the present invention. For example, the control system 20 may comprise a primary irrigation control system and a solid-state sensor control system that is communicably coupled with the primary irrigation control system. The primary irrigation control system and the solid-state sensor control system may be remotely located relative to each other and/or relative to the spans 14 and the towers 12.

The control system 20 may implement a computer program and/or code segments to perform the functions and method described herein. The computer program may comprise an ordered listing of executable instructions for implementing logical functions in the control system 20. The computer program can be embodied in any computer readable medium for use by or in connection with an instruction execution system, apparatus, or device, and execute the instructions. In the context of this application, a “computer readable medium” can be any physical apparatus that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, or device. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM).

The memory may be integral with control system 20, stand-alone memory, or a combination of both. The memory may include, for example, removable and nonremovable memory elements such as RAM, ROM, flash, magnetic, optical, USB memory devices, and/or other conventional memory elements. The memory may store various data associated with the operation of the irrigation system 10, such as the computer program and code segments mentioned above, or other data for instructing irrigation system 10 to perform the steps described herein. Furthermore, the memory may store, for example, a sensor reference location or direction, sensor calibration information, geographic location of the center pivot 16, length of each span 14, distance between the solid-state sensors 18, field sizes, geographic coordinates of field boundaries, desired angles of spans relative to adjacent spans, amounts of water or liquid to dispense, sequence/timing and parameters for actuating the spans 14 to pivot, etc. The various data stored within the memory may also be associated within one or more databases to facilitate retrieval of the information.

The control system 20 may use information received from the solid-state sensors 18 to determine if any of the spans 14 should be actuated to correct an undesired misalignment. For example, if one of the measured or calculated angles of one of the spans 14 is greater than a desired limit, the control system 20 to increase or decrease the speed of one of the towers 12 to correct the alignment of that span. Specifically, span joints and/or steerable wheels may be actuated (via a command signal from the control system 20) to pivot or rotate one of the spans 14 by an amount to correct alignment of at least one of the spans 14.

The control system 20 and its memory may be separately housed or jointly enclosed in or supported on a weatherproof housing for protection from moisture, vibration, and impact. Similarly, the control system 20 may be distributed through several different electronic modules, which in some embodiments of the invention may be integrated with one or more of the solid-state sensors 18. The housing may be constructed from a suitable vibration- and impact-resistant material, such as, for example, steel, plastic, nylon, aluminum, or any combination thereof and may include one or more appropriate gaskets or seals to make it substantially waterproof or resistant. The housing(s) may be positioned anywhere on the irrigation system 10.

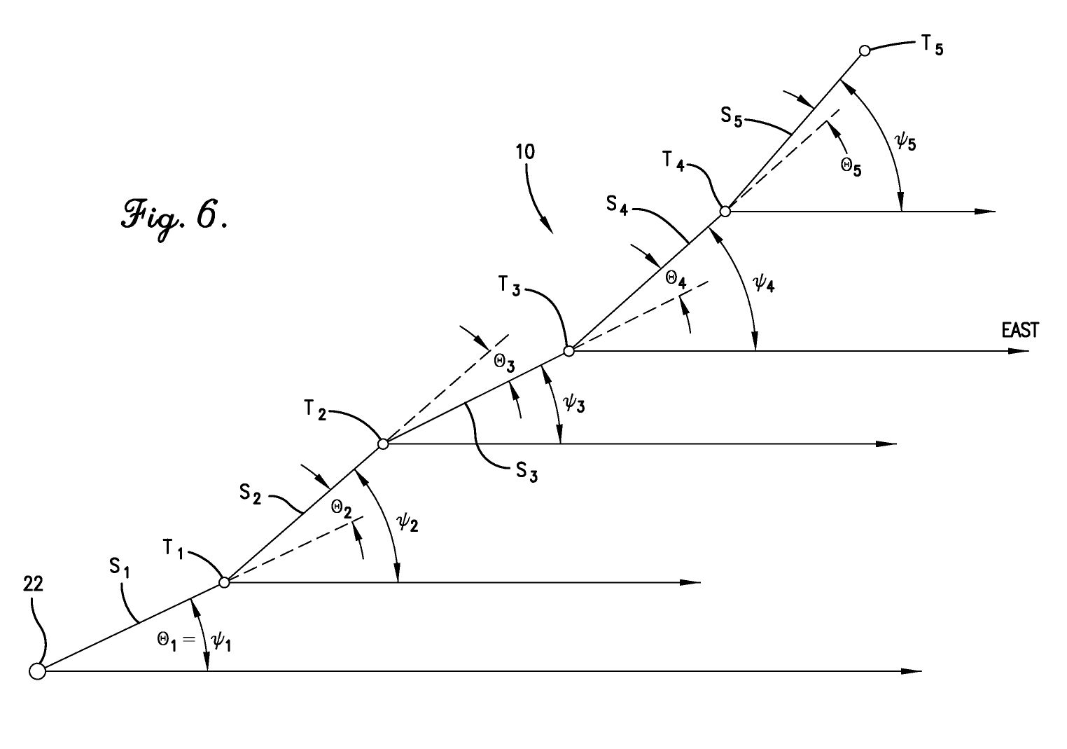

In use, the solid-state sensors 18 may each be hard-mounted to one of the spans 14 and/or one of the towers 12. Upon initial setup, the solid-state sensors 14 may be calibrated to a reference location, a reference axis, and/or a reference direction relative to a geomagnetic field of Earth (e.g., North, South, East, West). For example, in FIG. 6, the reference direction for control system 20 could be set such that each measured angle is taken with respect to an x-axis pointing east or aligned with a boundary of the field. The solid-state sensors may return angle measurements to the control system 20 for use in calculating relative or absolute alignment and/or location of each of the spans 14 and/or the towers 12.

For example, as illustrated in FIG. 6, the spans 14, towers 12, and/or their associated solid-state sensors 18 may be identified 1 through i, where i is the total number of spans 14. So, for example, in FIG. 6, i=5, and the spans 14 are each labeled S₁, S₂, S₃, S₄, and S₅, while the towers 12 are each labeled T₁, T₂, T₃, T₄, and T₅. The solid-state sensors 18 may return an angle measurement φᵢ of the i^{th} span with respect to the x-axis. So, for example, the solid-state sensors 18 may return angles φ₁, φ₂, φ₃, φ₄, and φ₅. Each of the angles identified in FIG. 6 by Θᵢ may be the angle of span i with respect to span i−1 for i>1, and Θ₁=φ₁. Using this information, the control system 20 may calculate relative angular alignment of each adjacent tower 12 via the following equation: Θₙ=φₙ−φₙ₋₁. Therefore, the angular alignment of each of the spans 14 and/or towers 12 relative to the x-axis may be determined. Furthermore, these measured and calculated angles may be used along with known lengths of the spans 14 and a known location (e.g., geographic coordinates) of the center pivot 22 to determine positions of each of the towers 12 and/or spans 14 in the field. As noted above, a location of the center pivot 22 and/or lengths of the spans 14 may be stored in the memory of the control system 20 or accessed from another database by the control system 20.

As noted above, the solid-state sensors 14 may include digital compasses and/or IMUs. Therefore, in some embodiments of the invention, digital compasses may provide the angles φᵢ to the control system 20 to determine alignment and/or location of a given span or tower. In other embodiments of the invention, IMUs may send acceleration, angular acceleration, angular rotation, relative position and/or heading information to the control system 20, which may use these readings along with a dead-reckoning algorithm to determine the angles φᵢ. Then, the control system 20 may solve for angle Θᵢ as disclosed above and determine alignment and/or location of a given span or tower.

If the solid-state sensors 18 only include digital compasses, the digital compasses may send the angles measured with respect to the reference direction or the reference axis. However, some fields contain buried wires, pipes, or other items which can interfere with measurements taken by the digital compasses. Therefore, in some embodiments of the invention, these measurements may be adjusted or corrected with a dead reckoning system. For example, IMUs may be used in combination with digital compasses, and the measurements of the IMUs can be used by a dead-reckoning algorithm to cross-check the measurements from the digital compasses and correct erroneous measurements received from any of the digital compasses. For example, if the angles calculated using measurements received from the one of the IMUs is greater than a predetermined threshold amount different than the angles measured and/or calculated by the corresponding one of the digital compasses, the control system 20 may use the measurements from the dead-reckoning algorithm instead of the measurements from the digital compass. Once the measurements from the digital compass are within the predetermined threshold amount of the angles calculated using the IMU measurements, the control system 20 may once again use the digital compass measurements to determine alignment and/or location of a given span or tower.

In some embodiments of the invention, the control system 20 may use the calculated alignment angles to determine an amount of correction required. For example, in some embodiments of the invention, the towers 12 may each be independently actuated, and one or more of the towers 12 may be commanded to speed up or slowdown in order to correct excessive lag or lead detected via the solid-state sensors 18.

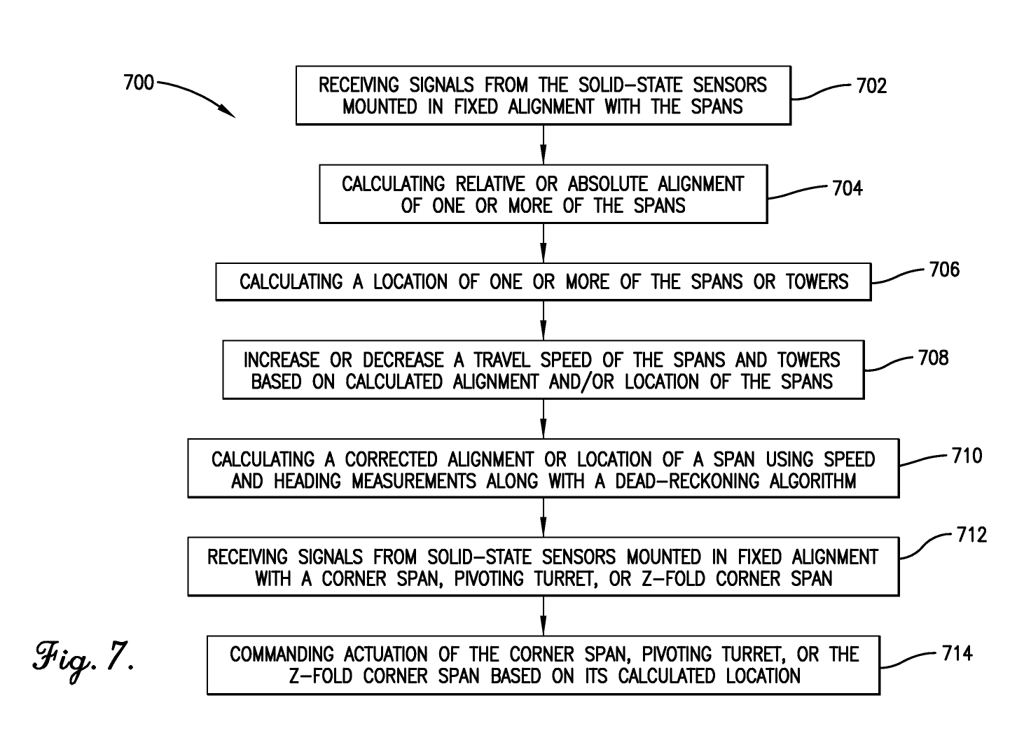

The flow chart of FIG. 7 depicts the steps of an exemplary method 700 of calculating and using alignment and/or position of the spans 14 of the irrigation system 10 in more detail. In some alternative implementations, the functions noted in the various blocks may occur out of the order depicted in FIG. 7. For example, two blocks shown in succession in FIG. 7 may in fact be executed substantially concurrently, or the blocks may sometimes be executed in the reverse order depending upon the functionality involved.

The method 700, as illustrated in FIG. 7, may comprise a step of receiving signals from the solid-state sensors 18, as depicted in block 702. As noted above, the signals from the solid-state sensors 18 may represent speed, heading, and/or an angle with respect to the reference direction relative to the geomagnetic field of Earth. Then the method may comprise a step of calculating relative or absolute alignment of one or more of the spans 14 using the signals received from the solid-state sensors 18, as depicted in block 704. Calculating alignment is described in detail above in reference to FIG. 6. Specifically, the step 704 of calculating span alignment (or misalignment) may include, for example, receiving a first angle of a first span with respect to the reference direction from a first sensor mounted in fixed alignment with the first span and receiving a second angle of a second span with respect to the reference direction from a second sensor mounted in fixed alignment with the second span. Then an angle of misalignment between the first span and the second span may be calculated by subtracting the first angle from the second angle.

The method 700 may also include a step of calculating a location of one or more of the spans 14 or towers 12 using the signals received from the solid-state sensors 18, as depicted in block 706. The step 706 of calculating span location may include the steps of accessing a stored geographic location of the center pivot 22 and stored lengths of the spans 14 and then calculating the location of one or more of the spans using speed measurements from the solid-state sensors 18, heading measurements from the solid-state sensors 18, angle measurements from the solid-state sensors 18, the geographic location of the center pivot 22, and/or the lengths of the spans 14.

The method 700 may further comprise a step of commanding actuators to independently increase or decrease a travel speed of the spans 14 and towers 12 based on the calculated alignment and/or the location of the spans 14, as depicted in block 708. As described above, these calculations and commands may be performed by the control system 20 communicably coupled with the solid-state sensors 18. In some embodiments of the invention, the method 700 may comprise a step of calculating a corrected alignment or location of one or more of the spans 14 using the speed and heading measurements from the solid-state sensors 18, along with a dead-reckoning algorithm stored in or accessible by the control system 20, as depicted in block 710.

Although the present invention is described herein for use with center pivot irrigation systems, the present invention may also be used to calculate relative and absolute alignment of spans for a lateral-move irrigation system. Relative alignment may refer to the alignment of the spans 14 relative to each other and absolute alignment may refer to alignment of the spans 14 relative to the reference direction with respect to the geomagnetic field of Earth. For example, the information received from the solid-state sensors 18 may be used by the control system 20 for keeping left and right sides of the lateral more closely aligned.

Additionally, the present invention may be used on center-pivot or lateral-move irrigation systems having various types of spans, such as corner spans, pivoting turrets, or Z-fold corner spans. Each of these types of spans may include one or more of the solid-state sensors 18 fixed thereto or in fixed alignment therewith. For example, the present invention may be used with dead-reckoning-based corner irrigation systems to eliminate the need for buried wires or GPS units. In particular, if the solid-state sensors 18 have sufficiently high sensitivity and sufficiently low drift over time, calculation of a tower's position or a span's position using the methods described herein may be utilized to determine when to deploy a pivoting turret on an end tower (i.e., when an outer-most tower of a center-pivot irrigation system is approaching a corner of the field). For a Z-fold corner span, each pivoting segment of the Z-fold corner span may have one of the solid-state sensors 18 associated therewith to determine relative angles of the segments and adjacent spans. In the case of a Z-fold corner span at a far end of a center-pivot irrigation system, the control system may determine locations of each of the pivoting segments of the Z-fold corner span.

In some embodiments of the invention, the method 700 may additionally include the steps of receiving signals from solid-state sensors 18 mounted in fixed alignment with a corner span, pivoting turret, or Z-fold corner span of the irrigation system 10, as depicted in block 712, then commanding actuation of the corner span, pivoting turret, or the Z-fold corner span based on a calculated location of the corner span, pivoting turret, or Z-fold corner span, as depicted in block 714. The control system 20 may calculate the location of the corner span, pivoting turret, or Z-fold corner span in the same manner as described above for the other spans 14.

In some embodiments of the invention, the control system 20 may be periodically calibrated to a known location or reference axis. For example, a laser beam, fixed beacon, GPS unit, switch, or other mechanism may be used to tell the control system 20 when at least one of the spans 14 is in a known position or angle. In these embodiments of the invention, the control system 20 may then compensate for any sensor drift that may happen over time.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A sensor system for use on an irrigation system having a plurality of towers configured to travel over portions of a field, a plurality of spans each extending between and connected to adjacent ones of the towers, and a fluid delivery system attached to or integral with the spans for outputting water into the field, the sensor system comprising:
a plurality of solid-state sensors each configured to be mounted in fixed alignment with at least one of the spans or towers and each configured to measure at least one of acceleration, angular acceleration, angular rotation, heading, and an angle with respect to a predefined reference direction, wherein the solid-state sensors comprise at least one of a digital compass, a solid-state gyroscope, a solid-state accelerometer, and an inertial measurement unit (IMU); and
a control system configured to receive measurements from each of the solid-state sensors, and to calculate at least one of alignment, rotational position, and location of at least one of the spans.

2. The sensor system of claim 1, wherein the control system is configured to output command signals to actuators of at least one of the towers or spans to speed up or slow down based on the calculated alignment of the spans.

3. The sensor system of claim 1, wherein one of the plurality of spans is a pivoting turret, wherein at least one of the solid-state sensors is configured to be attached to the pivoting turret, wherein the control system is configured to output command signals to actuate the pivoting turret based on measurements received from the at least one of the solid-state sensors configured to be attached to the pivoting turret.

4. The sensor system of claim 1, wherein one of the plurality of spans is a Z-fold corner span, wherein at least one of the solid-state sensors is configured to be attached to the Z-fold corner span or a tower to which the Z-fold corner span is attached, wherein the control system is configured to output command signals for actuating the Z-fold corner span based on measurements received from the at least one of the solid-state sensors configured to be attached to the Z-fold corner span.

5. The sensor system of claim 1, wherein the plurality of spans include a first span or first tower and a second span or second tower, wherein the solid-state sensors comprise a first sensor configured to be mounted in fixed alignment with the first span or first tower and a second sensor configured to be mounted in fixed alignment with the second span or second tower, wherein the control system is configured to receive from the first sensor a first angle with respect to the reference direction and to receive from the second sensor a second angle with respect to the reference direction, wherein the control system is configured to calculate an angle of misalignment between the first span and the second span by subtracting the first angle from the second angle.

6. The sensor system of claim 1, wherein the irrigation system is a center-pivot irrigation system and the spans and towers rotate about a fixed center pivot, wherein a geographic location of the center pivot and lengths of the spans are stored by or accessible by the control system, wherein the control system is configured to use at least one of acceleration measurements from the solid-state sensors, angular acceleration measurements from the solid-state sensors, angular rotation measurements from the solid-state sensors, heading measurements from the solid-state sensors, angle measurements from the solid-state sensors, the geographic location of the center pivot, and the lengths of the spans to calculate a location of at least one of the spans or towers.

7. The sensor system of claim 1, wherein the irrigation system is a lateral-move irrigation system and the control system is configured to calculate relative and absolute alignment of any of the spans based on angle measurements received from the solid-state sensors.

8. A center-pivot irrigation system comprising:
a center pivot;
a plurality of towers configured to move about the center pivot;
a plurality of elongated rigid spans each extending between and connected to adjacent ones of the towers;
a fluid delivery system comprising one or more conduits attached to or integrally formed with at least a portion of the spans and configured to output water from orifices formed therein or therethrough;
a plurality of solid-state sensors each mounted in fixed alignment with one of the spans or towers and each configured to measure at least one of acceleration, angular acceleration, angular rotation, heading, and an angle with respect to a fixed reference direction; and
a control system configured to receive measurements from each of the solid-state sensors and to calculate at least one of alignment, rotational position, and location of at least one of the spans.

9. The center-pivot irrigation system of claim 8, wherein the control system is configured to command actuators of at least one of the towers or spans to speed up or slow down based on the calculated alignment of the spans.

10. The center-pivot irrigation system of claim 8, wherein the solid-state sensors comprise at least one of a solid-state gyroscope, a solid-state accelerometer, a digital compass, and an inertial measurement unit (IMU).

11. The center-pivot irrigation system of claim 8, wherein the plurality of spans further comprises a pivoting turret having at least one of the solid-state sensors attached thereto, wherein the control system is configured to actuate the pivoting turret based on a rotational position of the pivoting turret calculated by the control system.

12. The center-pivot irrigation system of claim 8, wherein the plurality of spans further comprises a Z-fold corner span having at least one of the solid-state sensors attached thereto, wherein the control system is configured to actuate the Z-fold corner span based on a location of the Z-fold corner span calculated by the control system.

13. The center-pivot irrigation system of claim 8, wherein the spans comprise a first span and a second span, wherein the solid-state sensors comprise a first sensor mounted in fixed alignment with the first span or tower and a second sensor mounted in fixed alignment with the second span or tower, wherein the control system is configured to receive from the first sensor a first angle with respect to the reference direction and to receive from the second sensor a second angle with respect to the reference direction, wherein the control system is configured to calculate an angle of misalignment between the first span and the second span by subtracting the first angle from the second angle.

14. The center-pivot irrigation system of claim 8, wherein the control system is configured to receive at least one of acceleration measurements, angular acceleration measurements, angular rotation measurements, heading, and angle measurements from the solid-state sensors and to use the measurements, along with a dead-reckoning algorithm, to identify and correct for any errors in the angle measurements received from the solid-state sensors.

15. A method of determining and correcting for at least one of alignment and position of a plurality of spans traveling on a plurality of towers of a center-pivot irrigation system configured to output liquid in a field, the method comprising:
receiving signals with a control system from a plurality of solid-state sensors each mounted in fixed alignment with one of the spans, wherein the signals represent at least one of acceleration, angular acceleration, angular rotation, heading, and an angle with respect to a fixed reference direction wherein the solid-state sensors comprise at least one of a solid-state gyroscope, a solid-state accelerometer, a digital compass, and an inertial measurement unit (IMU);
calculating with the control system relative or absolute alignment of at least one of the spans using the signals received from the solid-state sensors; and
calculating with the control system a position of at least one of the spans or towers using the signals received from the solid-state sensors.

16. The method of claim 15, further comprising the control system commanding actuators to independently increase or decrease travel speed of the towers and spans based on at least one of the alignment and the location of the spans as calculated by the control system.

17. The method of claim 15, wherein the plurality of spans includes a pivoting turret or a Z-fold corner span having at least one of the solid-state sensors attached thereto, the method further comprising the control system commanding actuation of the pivoting turret or the Z-fold corner span based on a location of the pivoting turret or Z-fold corner span calculated by the control system.

18. The method of claim 15, further comprising the control system accessing a stored geographic location of the center pivot and stored lengths of the spans, and the control system calculating a location of at least one of the spans using at least one of acceleration measurements from the solid-state sensors, angular acceleration measurements from the solid-state sensors, angular rotation measurements from the solid-state sensors, heading measurements from the solid-state sensors, angle measurements from the solid-state sensors, the geographic location of the center pivot, and the lengths of the spans.

19. The method of claim 15, wherein the spans include a first span and a second span, wherein the solid-state sensors include a first sensor mounted in fixed alignment with the first span and a second sensor mounted in fixed alignment with the second span, the method further comprising:
receiving with the control system a first angle with respect to the reference direction from the first sensor;
receiving with the control system a second angle with respect to the reference direction from the second sensor; and
calculating with the control system an angle of misalignment between the first span and the second span by subtracting the first angle from the second angle.

20. The method of claim 15, further comprising the control system calculating a corrected alignment or location of at least one of the spans using the measurements received from the solid-state sensors, along with a dead-reckoning algorithm stored in or accessible by the control system.

21. The method of claim 15, further comprising calibrating the control system based on a known location.

22. The method of claim 15, wherein the fixed reference direction is a fixed direction with respect to a geomagnetic field of the earth.
